(19) United States
(12) Patent Application Publication
(10) Pub. No.: US 2009/0089238 A1
(43) Pub. Date: Apr. 2, 2009

(54) Knowledge management portal for rapid learning and assessment of science

(76) Inventor: HENRY COLBURN STEVENSON-PEREZ, Kensington, MD (US)

Correspondence Address: Dr. MISHRILAL JAIN, 11700 OLD GEORGETOWN Rd. # 1501, NORTH BETHESDA, MD, 20852, US

(21) Appl. No.: 11/904,120

(22) Filed: Sep. 27, 2007

(51) Int. Cl. G06N 5/00

(52) U.S. Cl. 706/50

(57) ABSTRACT

The present invention is related to a scientific knowledge management learning-portal system and method that provides appropriate levels of programming and feedback for allowing end-users to rapidly grasp science in its most-elemental and most-useful aspects, specifically the mastery of the tools for assessing, measuring, and improving scientific-value. The system and method of the invention also teaches appropriate use of scientific knowledge management tools to any person who is suitably prepared to learn how to operate such a scientific-value oriented learning system, without requiring said person to have prior knowledge of the physical sciences, in substantially less time than that required for achieving similar levels of scientific skills-mastersy through currently known conventional methods, systems or devices.

### FIELD OF THE INVENTION

The present invention is related generally to devices and systems for rapidly learning to appropriately process and grasp scientific ideas, concepts, principles, conversations and offerings. More specifically the present invention is related to a scientific knowledge management learning-portal and tool-set for rapidly assessing, measuring and improving scientific value.

It is noted at the very outset that, the term “science” or “physical science” as used herein means such natural sciences as physics, chemistry, biology, environmental science, information technology, engineering, systems analysis and design, medicine and the like, and excludes such disciplines as philosophy, theology, music and the like.

### BACKGROUND OF THE INVENTION

Presently known methods for teaching and/or learning the core concepts and the basic tools of modern science generally include such techniques as formal classroom lecture presentations, laboratory experimentation exercises, memorizing scientific reference texts, computer-based professional reference sites, and the like. All such traditional or conventional methods tend to require many years of formal scientific education and intense studying, sometimes up to post-doctoral level, in order to be reasonably proficient in understanding the subject matter. Such educational approaches require even more time on the part of the end-user in order to be able to properly assess, measure and improve scientific value.

In standard scientific settings and learning environments, it is generally assumed that such scientific-value assessment, measurement and improvement endeavors are the province of a trained professional usually called a ‘scientist’ or a ‘scientist-in-training’ and such scientific-value assessments are generally not considered appropriate for individuals who do not possess formal scientific education and academic training.

For the ordinary non-scientist end-user/consumer, the difficulty in learning or grasping modern scientific knowledge, offerings and conversations becomes even more complicated by the explosive development of new dysfunctional syndromes, phenomena that have progressively affected all levels of modern society. Typical of such new dysfunctional scientific syndromes are:
The Scientific-Information-Overload Syndrome,
The Scientific-Knowledge-Overload Syndrome,
The Scientific-Discipline-Fragmentation Syndrome,
The Scientific-Disposability Syndrome, and
The Scientist-Centric Discoveries and Offerings Syndrome.

Although many of these terms are already in common usage, the precise scientific definitions of these science-related syndromes, particularly as related to the specific technical field and the claims of this invention, are set forth in the ‘Definitions of Key Scientific Terms’ section (below).

In view of such rapidly-evolving complex dysfunctional phenomena in the scientific world, it would be desirable to have an easier, more efficient, time-saving, and most-importantly, end-user-centric system for grasping science in all of its important aspects, particularly in light of the rapidly-evolving pace of discovery in science and technology in the modern competitive industrial economies of the world.

It is important to note that with the advent of the Internet, particularly with the growth of those Internet sites that offer hyper-linking availability of scientific definitions and terminology, an appearance is created that an ordinary non-scientist might readily be able to gain appropriate levels of guidance and instruction about the value of modern scientific discoveries and offerings. A very popular example of such a hyper-linked, expert-level, scientific website might be found in certain Wikipedia entries (www.wikipedia.org).

However, in the vast majority of instances, ordinary non-scientist end-users of such scientific offerings and conversations find such Internet-based hyper-linked information either too complex or too difficult to really understand; as a result, they tend to feel frustrated by scientific information-overload or feel confused by the multiplicity of legitimate conflicting views that are contained within science itself. Such frustration may result in the negation of the understanding of scientific-value by an ordinary end-user, an outcome that is exactly opposite of the desired result. (http://www.abc.net.au/catalyst/stories/s1625368.htm http://www.ias.ac.in/currsci/mar102000/EDITORIAL.PDF).

Indeed, in the emerging information-age economies of the world, ordinary and even professional-level end-users of scientific offerings experience increasing levels of scientific knowledge-overload (http://www.ias.ac.in/currsci/mar102000/EDITORIAL. PDF).

At a superficial level of analysis, it would seem that those Internet websites that contain highly-specialized scientific resources, such as those sponsored by government or major non-profit organizations (http://www.sciencemag.org/current.dtl), should also be able to reduce this scientific knowledge-overload experience by end-users. Yet ironically, because of the many different highly-sophisticated approaches to the same specific scientific issue, and because of the highly-specialized language and jargon used to express widely-differing scientific approaches, these scientific-expertise websites tend to exacerbate the level of scientific knowledge-overload for most professional end-users (‘scientific knowledge-overload’ refers to specific patterns of scientific information that constitute authentic predictive scientific knowledge, yet are presented in a format that is not easily comprehensible and/or actionable by the end-user.)

This scientific knowledge-overload syndrome is sometimes referred to as a manifested high ‘scientific know-do gap’; i.e., scientific-knowledge that appears truthful, yet not easily intelligible or actionable. The rapidly-expanding impact of the scientific knowledge-overload syndrome further erodes the end-user understanding of true scientific-value.

Moreover, at the very highest levels of professional scientific training, a new level of complexity and dysfunction has emerged, commonly known as the ‘professional silo syndrome’, in which scientists that specialize in one particular sub-discipline are literally unable to meaningfully inter-connect with the offerings of other scientist-colleagues in a different scientific sub-discipline (http://www.doubletongued.org/index.php/dictionary/silo/).The challenges to economic productivity that are posed by this professional scientific silo syndrome continue to grow, especially as scientific teams become progressively more global and more electronically-connected with colleagues working in other nations around the world. Such an inability to understand and appreciate the contributions of other scientist-colleagues in remote locations further contributes to the erosion of the understanding and improvement of authentic scientific-value.

In addition, the growth of pre-programmed disposability into many scientific solutions and offerings is another factor that tends to further erode the experience of scientific-value, particularly if the scientific discovery or offering does not possess the quality of scientific-sustainability (in general, scientific-sustainability represents the opposite of scientific-disposability, and is defined as the ability to craft new scientific products, structures and solutions that meet the scientific needs of current end-users, while also preserving scientific, economic, and ecological options for future generations).

In short, each of the above-mentioned newly-emerging, dysfunctional scientific syndromes severally, collectively and progressively tend to diminish the end-user's ability to understand the specific parameters of authentic scientific-value. In this state of confusion, the end-user/consumer of the scientific discovery process feels progressively powerless, as he/she finds him/herself unable to exercise personal control over the incessant barrage of scientific conversations, ideas, and offerings that characterize many of the new Post-industrial economies of modern societies.

The present invention includes a scientific knowledge management learning-portal that for the first time provides, particularly to those individuals without scientific expertise, a more efficient, time-saving and end-user-centric system for grasping, measuring and improving the full scientific-value of scientific discoveries and offerings. The scientific knowledge management learning-portal of the present invention provides end-users with control over the scientific-value of scientific conversations and offerings, both in face-to-face and in technology-assisted settings. Heretofore, no such scientific knowledge management learning-portal method and system was known or available.

### SUMMARY OF THE INVENTION

It is, therefore, an object of the present invention to provide a scientific knowledge management learning-portal, system and method for appropriate levels of programming, feedback, and new-skills learning that allows end-users, particularly individuals lacking a formal scientific education, to grasp science at its very-basic and useful aspects, specifically the mastery of the tools for assessing, measuring, and ultimately improving scientific-value.

It is an additional object of the present invention to teach the appropriate use of scientific knowledge management tools to any person who is prepared to rapidly learn how to operate such a scientific-value oriented learning-system, without requiring said person to have prior knowledge of the physical sciences, in substantially less time than that needed for learning through currently known conventional methods or devices. The scientific knowledge management learning-portal method and system is also useful to already-trained professionals for maximizing the value of scientific conversations and offerings.

It is a further object of the invention to remedy, minimize and/or prevent such dysfunctional syndromes that hinder the experience and the value of 21^{st} century science and technology, including:
The Scientific-Information-Overload Syndrome,
The Scientific-Knowledge-Overload Syndrome,
The Scientific-Discipline-Fragmentation Syndrome,
The Scientific-Disposability Syndrome, and
The Scientist-Centric Discoveries and Offerings Syndrome.

By minimizing and/or preventing these dysfunctional syndromes (defined in detail below), the end-user, regardless of formal academic scientific training, is able to exercise a significantly-increased control over the incessant offering of scientific theories, ideas and materials that characterize the new post-industrial economies of the modern world.

Various other objects and advantages of the invention will become evident from the following detailed description of the invention.

### BRIEF DESCRIPTION OF THE DRAWINGS

These and other objects, features and many of the attendant advantages of the scientific knowledge management learning-portal method and system will be better understood upon a reading of the following detailed description; especially when considered in connection with the accompanying drawings wherein:

FIG. 1 is a schematic overview representation of key elements of the Scientific Knowledge Management (SKM) Learning-Portal invention;

FIGS. 1B-1E are illustrative examples of the key steps in the operation of the Scientific Knowledge Management (SKM) Learning-Portal system and methodology.

FIG. 2 shows the outline of a representative study of the growth in the skills for assessing, measuring and improving scientific-value in 5 science-naïve ten year-old boys.

FIG. 2A shows the significant (p=0.000) growth in scientific-value assessment, measurement and improvement skills in 5 science-naïve ten year-old boys, following just six 90 minute SKM Learning-Portal training-sessions, over a period of about 3 weeks.

### DETAILED DESCRIPTION OF THE INVENTION

The above and various other objects and advantages of the present invention are achieved by a scientific knowledge management learning-portal method and system for use by an ordinary individual, without the requirement for any formal training in science, to enable said-user to rapidly learn how to assess, measure and improve the scientific-value of any scientific discovery, idea, principle, theory, conversation or offering, comprising the steps of:

a.) initiating the process with an individual who is motivated to learn this skill-set, including persons without prior knowledge of a science subject and without requiring said person to have more than high school reading skills, as well as by any trained scientific professional, to empower them to learn to operate a scientific knowledge management learning portal and tool-set that acquires scientific-data, scientific-information and scientific-knowledge in the context of the specified steps of the scientific method, while understanding the 10 core scientific levels of measurement of living systems, and while concurrently implementing scientific-sustainability approaches, either in a face-to-face or in a technology-assisted setting, that provides the end-user with a rigorous, end-user-driven, interactive learning field for assessing, measuring and improving scientific-value; then
(b) requiring the person in step (a) to completely follow the specific instructions for learning how to operate the scientific knowledge management learning-portal, including learning the pertinent terminology and functional interactive operations that govern the operation of the scientific knowledge management learning-portal; then
(c) requiring the person in step (b) to practice specific scientific problem-viewing and scientific problem-solving skills, as set forth in the scientific knowledge management learning portal by following instructions contained in said scientific knowledge management learning portal in an amount at least equal to or more than and in a time period substantially less than that of conventional method; then
(d) requiring said person in step (c) to verbally interact with other scientific knowledge management learning portal end-user participants, who have also become familiar with the operation and the language of the scientific knowledge management system for analyzing scientific problems and paradigms, in a setting of a group of persons treated similar to steps (b) and (c), with feedback in face to face or in a technology-assisted reinforcement setting in an amount at least equal to or more than and in a time period substantially less than that of conventional method; then
(e) repeating step (d) a plurality of times, over several days, in face-to-face sessions or via technology-assisted instruction, so that said individuals-in-training will acquire the ability to rapidly assess, measure or improve the value of a scientific topic, idea, conversation, discovery and/or offering, without face to face or technology-assisted supervision, in an amount at least equal to or more than, and in a time period substantially less than that required in conventional methods.

The protocol that governs the student's exposure to the operations of the scientific knowledge management learning-portal also includes a system for pre-testing and post-testing of the scientific knowledge management abilities and scientific value assessment, measurement and improvement skills acquired by said end-user individual, utilizing a timed and guess-proof card assortment process or a similarly-complex test of skills involving actual scientific experimentation, whereby said person is forced to rapidly evaluate the value of newly-acquired scientific knowledge and concepts, thus producing a set of individual objective scores for specific scientific knowledge management and scientific value assessment skills, that in turn can be utilized by both individual students and their instructors to direct further study to specific topic areas.

Each student in the operations of the scientific knowledge management learning-portal is also provided with a specific set of additional scientific knowledge management training reference-resources, in standard book format or using technology-assisted resources that relate to the specific scientific question(s) being explored by the student for scientific-value evaluation. This exploration of additional scientific in-depth study can further boost the student's skills in any measured area of deficiency, with regard to an individual's scientific knowledge management abilities and scientific-value assessment, measurement and improvement skills.

The proper operation of the scientific knowledge management learning-portal further comprises of a scientific learning-journal system, using actual scientific laboratory journals or suitable technology-assisted substitutes, for deliberately registering and recording conceptual advances of each student with regard to scientific knowledge management and scientific-value, including an array of recording options for new scientific ideas, new scientific questions and new scientific references that are manually (for a standard laboratory notebook) or automatically (for the technology-assisted format) organized in a readily-retrievable format as contained in said scientific knowledge management learning portal for subsequent use by said person in a variety of ways, including periodic re-introduction of any specific scientific advance onto said.person's calendar, computer-screen or similar memory-enhancing device.

The system of the present invention can be better visualized as a type of bio-feedback system that allows the user (regardless of prior science background) to “reprogram” the mental skills required for mastery of the central scientific concepts and principles that must be understood in combination and simultaneously, in order to produce a realistic assessment of the authentic scientific-value of any scientific conversation, idea, discovery and/or offering in a very short period of time. In the context of scientific conversations, this advance in rapid skills-building with regard to the assessment, measurement and improvement of scientific value places control of the scientific conversation in the hands of the end-user. For this reason, the scientific knowledge management learning-portal of the present invention is designed as an end-user-centric system. The importance of this end-user-centric feature in scientific matters becomes all the more important especially since the industrialized nations of the world are entering a post-industrial period characterized by an emphasis on the advancement and application of science and technology.

Most of the technical and scientific terms that apply with specificity to this invention have been formally articulated in the ‘Definitions of Key Scientific Terms’ section below. However, it is noted that the definitions should not be taken in isolation, but understood in proper context and in its integrated conceptual framework. All other technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

It should be noted that the physical sciences and mathematics are separate academic and professional cultures unto themselves, with a separate set of nonintuitive concepts and an exclusionary operational languages surrounding each of them. Each sub-set of science disciplines centers around a separate body of knowledge and a separate language to communicate the ideas of the discipline. For this reason, the acquisition of the pertinent skills for mastering the science concepts and language for addressing all scientific disciplines creates a steep learning curve for most novices. Usually about seven years of study are required to master the concepts and the pertinent language of most science subsets by the conventional methods. (Examples: immunology, genetics, engineering, oncology, information technology, anesthesiology, biomedical-engineering, opthalmology, systems design, and the like).

The term “conventional” or “traditional” as used herein means those known methods or devices and the like which are commonly and ordinarily used in routine practice. The term “substantially less” as used herein, means at least two or more times less, preferably tens or hundreds of times less.

### Definition of Key Scientific Terms:

‘Science’: Although defined earlier herein, it may be mentioned that the word ‘science’ derives from the Latin ‘scientia’, meaning ‘knowledge,’ entailing a rigorous system of thought and a specific pattern of disciplined inquiry for gaining facts and additional predictive knowledge about the operation(s) of nature and the universe, of which humans are a part, through a systematic process known as ‘Scientific Method’.
   Current scientific thinking holds that all of the material dimensions of our currently-known universe, including all known forms of living systems, are rooted at the quantum level (basically below the size of the atom) in various forms of energy: Quantum-physics is currently the best scientific model for explaining the operation of very small units of matter (basically sub-atomic particles) in the known universe.
   At the level of very, very large (beyond-Earth) units of matter, modern science holds that the known universe is about 13.5 billion years old and had its beginnings in the explosive expansion of a very small-sized original structure of pure energy. These basic scientific tenets are generally called the ‘Big Bang’ and ‘Inflation’ theories.
   Although not usually perceived by humans in normal day-to-day experiences on Earth, scientific thinking currently holds that such Big Bang and Quantum-physics forces are still operating in the realm of the universe that lies beyond-Earth, as well as at the sub-atomic level within the Earth and its inhabitants: Many of these powerful forces can be measured scientifically.
   Scientists currently hold that all forms of matter in our universe, including the structure and function of all Earth-bound material and life-forms, are subject to the basic universal laws and forces of the natural world; including gravitational forces, electromagnetic forces, conservation of energy and momentum in all material systems, as well as the impact of various forces of entropy upon all material systems.
   Science assumes and affirms, as the best-available scientific theory, that all known forms of life in the universe, and indeed all of the non-living preconditions for life in our universe, are in a constant state of change, ultimately resulting in an increasing and progressive level of scientifically-measurable complexity, also applicable to human species. At the level of living systems, this basic scientific tenet is generally termed The Theory of Evolution.
The ‘Scientific-Method’: A disciplined and proscribed pattern of inquiry, thought and action that is used by scientists to gain additional scientific-knowledge about the natural cause and effect laws that govern the universe. In its most basic form, the scientific method usually follows the following steps:
   A question under consideration.
   The formulation of an hypothesis about the measurable natural forces that govern the objects in question.
   Predicting specific results, based upon the stated hypothesis.
   Design of a controlled experiment to test the hypothesis.
   Appropriate collection of experimental results.
   Proper interpretation of the collected experimental data.
   Accurate and complete sharing of findings, materials and methods with others
   Seeking reproducibility and verification of experimental findings by others.

Human knowledge is considered to be ‘scientific-knowledge’ only when a critical review of such knowledge ascertains that it continues to provide reproducible scientifically verifiable evidence based on the specific steps of the ‘Scientific Method’ outlined above (http://www.cdc.gov/ncbddd/folicacid/excite/files in use/steps of the scientific method.htm).

Viewed in this perspective, the object or purpose of science is not to engage in definitively ‘proving’ or ‘disproving’ any claim, assertion or ‘the truth’; instead, scientists report whether or not any given scientific fact, observation and/or prediction is consistently reproducible and verifiable through the experimental findings or replication of others.
A ‘Scientific Discipline’: A specific sub-field of scientific inquiry within the overall field of science. Most scientific disciplines can be recognized by their distinctive focus of attention with regard to scientific inquiry, the specialized tools used to pursue research in the selected sub-field of science, and (increasingly) highly-specialized technical language (sometimes referred to as scientific-jargon) used by scientific practioners in the scientific-discipline.
‘Scientific-Data’: Essentially the infinite facts of the universe, the vast majority of which are functionally silent and invisible to human observers, nevertheless derivable through methodology and tools employed by scientists.
‘Scientific-Information’: In its most useful form, a specific pattern of scientific-data that places a demand for conscious attention upon the human mind. Such attention-getting scientific-data patterns, on their own, usually do not provide the end-user with useful specific instructions or meaning.
‘Scientific-Knowledge’: A specific pattern of scientific-information that allows scientists to predict responses, based upon an enhanced understanding of the natural cause and effect, laws that govern the operation(s) of the universe. By definition, this level of understanding is the stated goal of all scientific endeavors.
‘Scientific-Learning’: Gaining, usually a perceptible improvement, in the level of scientific understanding about the natural cause and effect, laws that govern the workings of the universe, using the scientific method. The goal of all scientific learning is to acquire new scientific-knowledge (i.e., the acquisition of abilities to understand, thus manipulate and predict the result as related to the natural laws that govern the universe).
‘Scientific-Value’: In its broadest sense, scientific value is an end-user experience of comfort, in himself/herself, as well as comfort with the commitment that is being made by the end-user to the scientific idea, discovery, solution, conversation, structure or offering under consideration.
   Scientific-value increases in directly proportion to the intensity and the durability of the above-described experience. Scientific-value also increases in direct proportion to the number of end-users who experience the above-cited experience in response to the same scientific idea, discovery, solution, conversation, structure or offering under consideration.

In science, such experiences of high scientific-value increase in direct proportion to the rigor with which the supporting disciplines have been applied appropriately to the scientific idea, discovery, structure, conversation, solution or offering in relation to the following specific parameters:
The Scientific Method (i.e., the degree of reproducibility of the new evidence),
The Scientific Data to Information to Knowledge Learning Pathway (i.e., the degree of predictability of the new scientific best practices),
The 10 Scientifically-Measurable Dimensions of Living Systems (i.e., the degree of understanding of the levels of inter-connectedness in the new phenomena), and
The Scientific-Sustainability Tools and Approaches (i.e., the degree of enduring usefulness of the discovery).

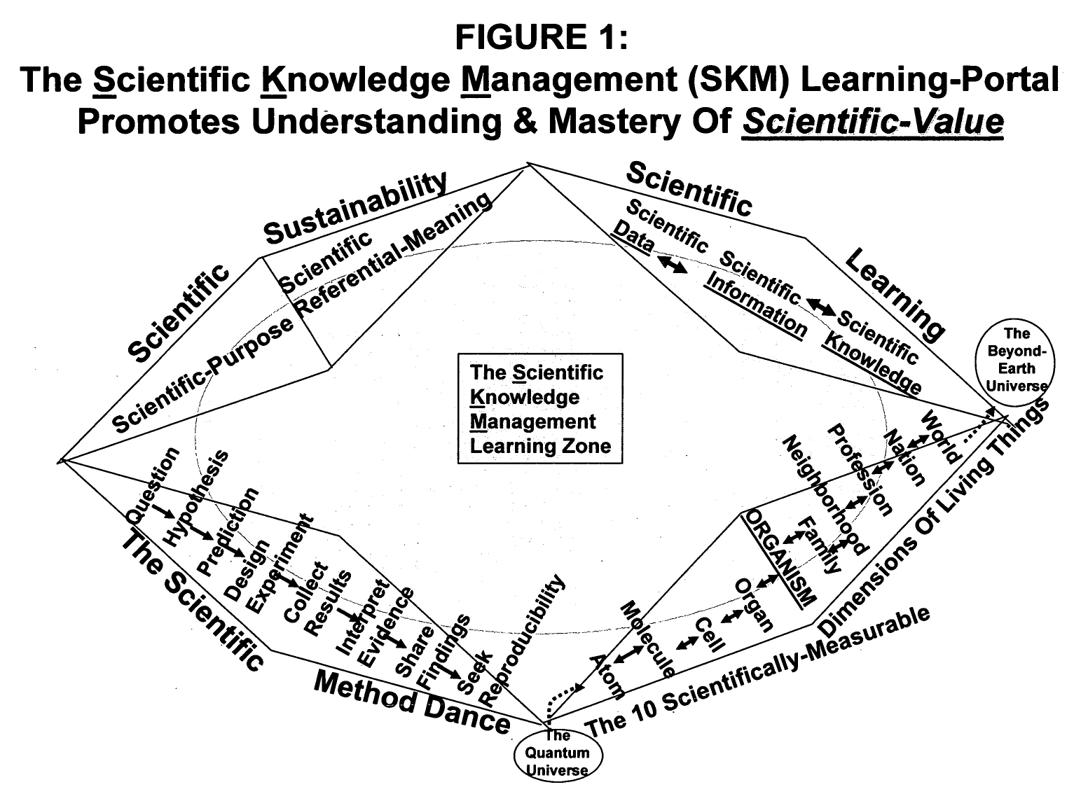

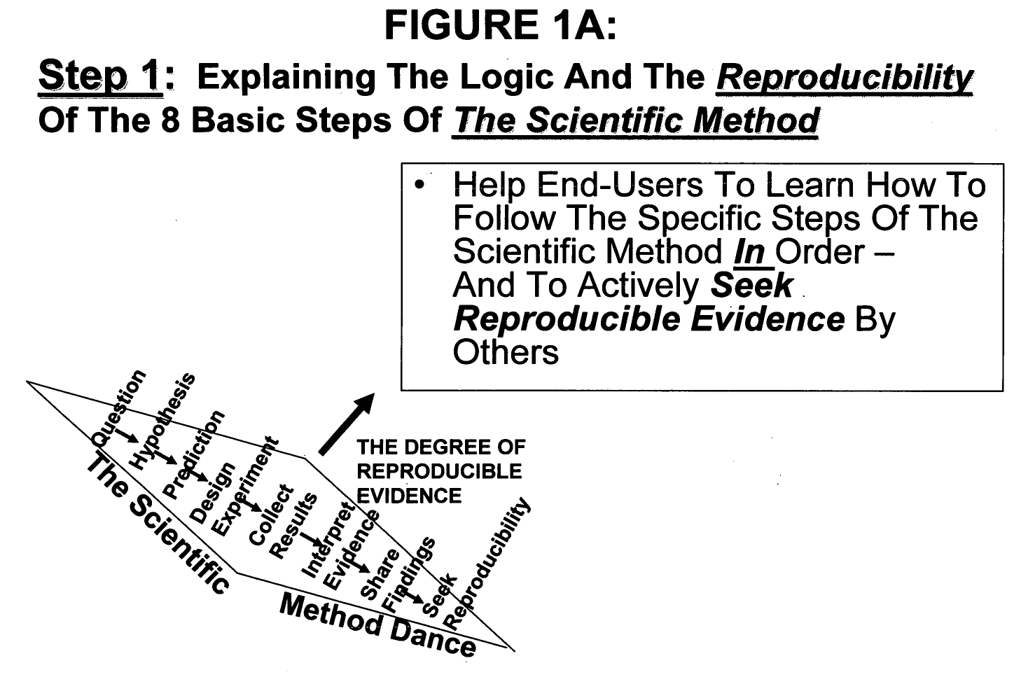

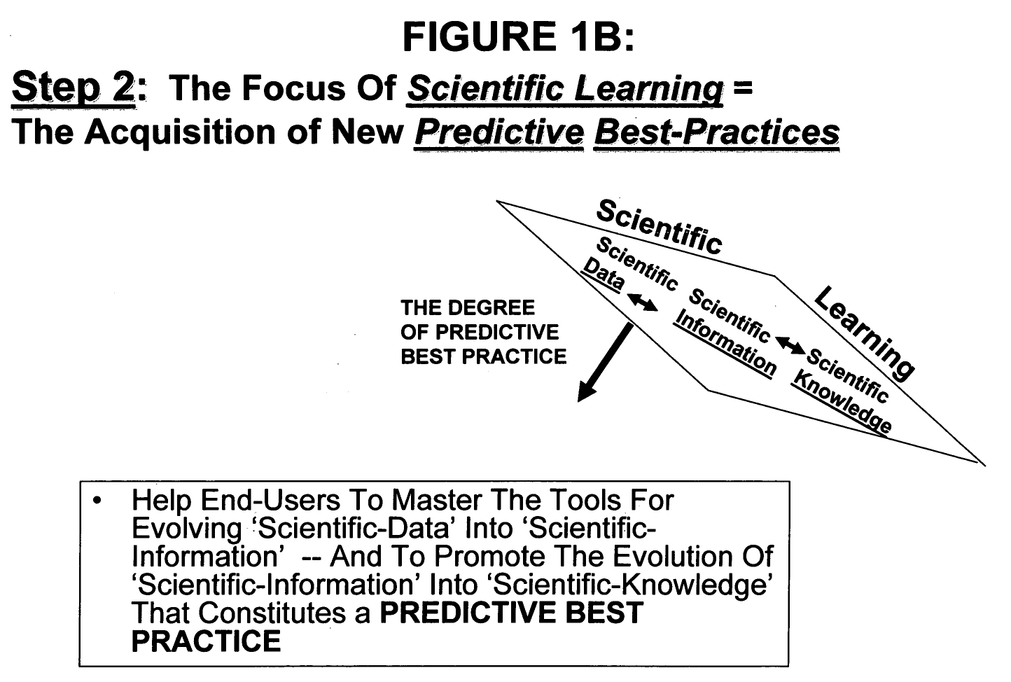

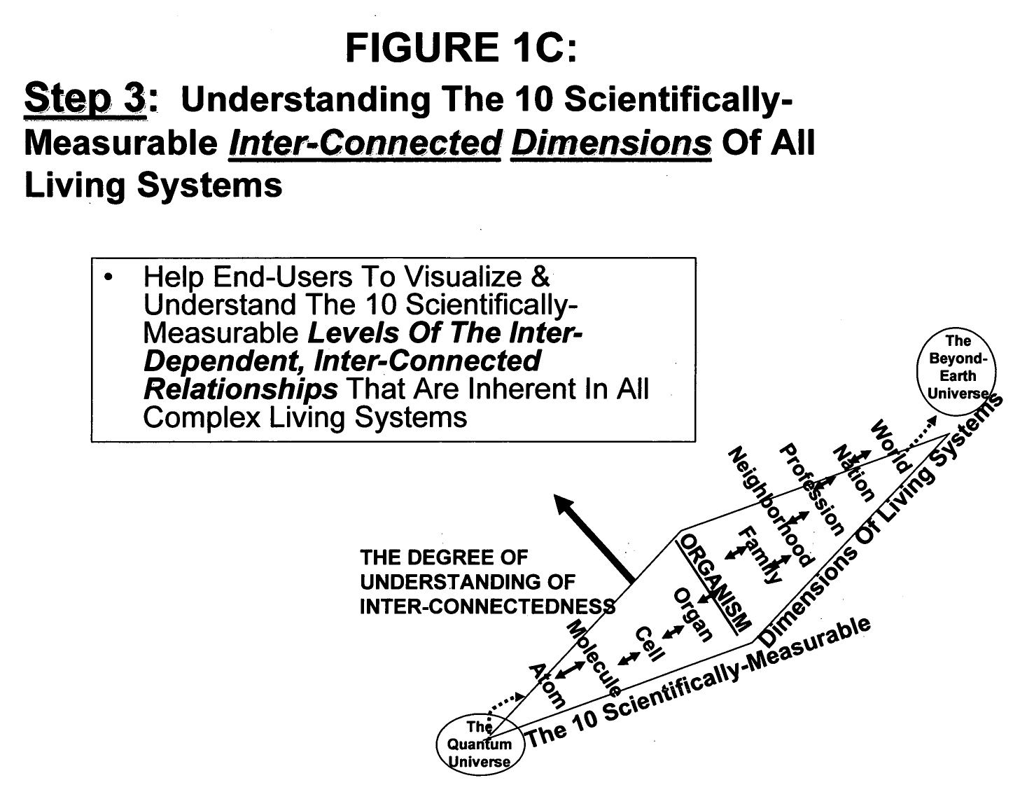

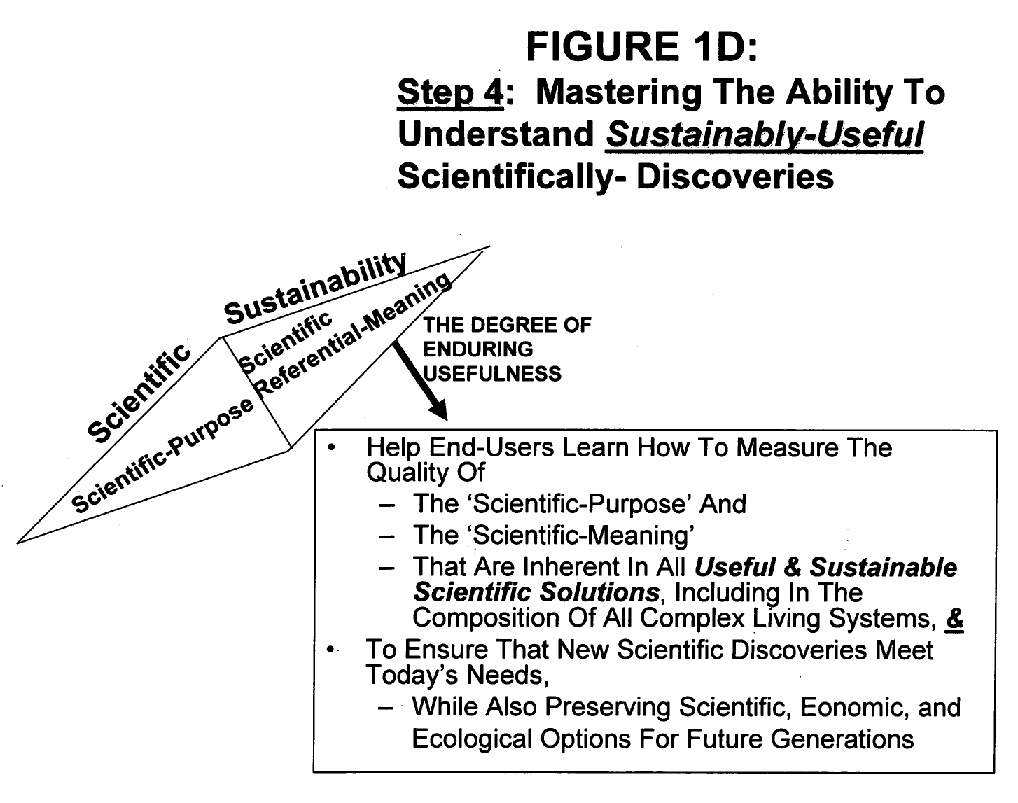

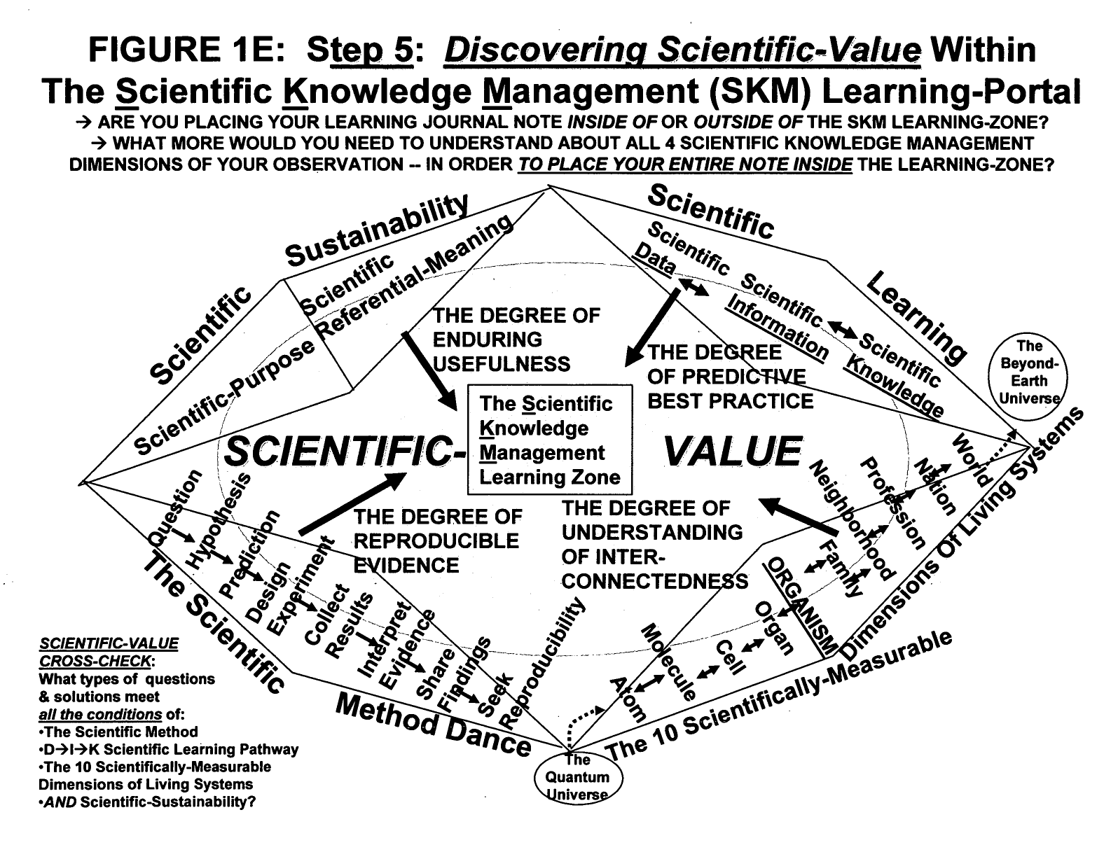

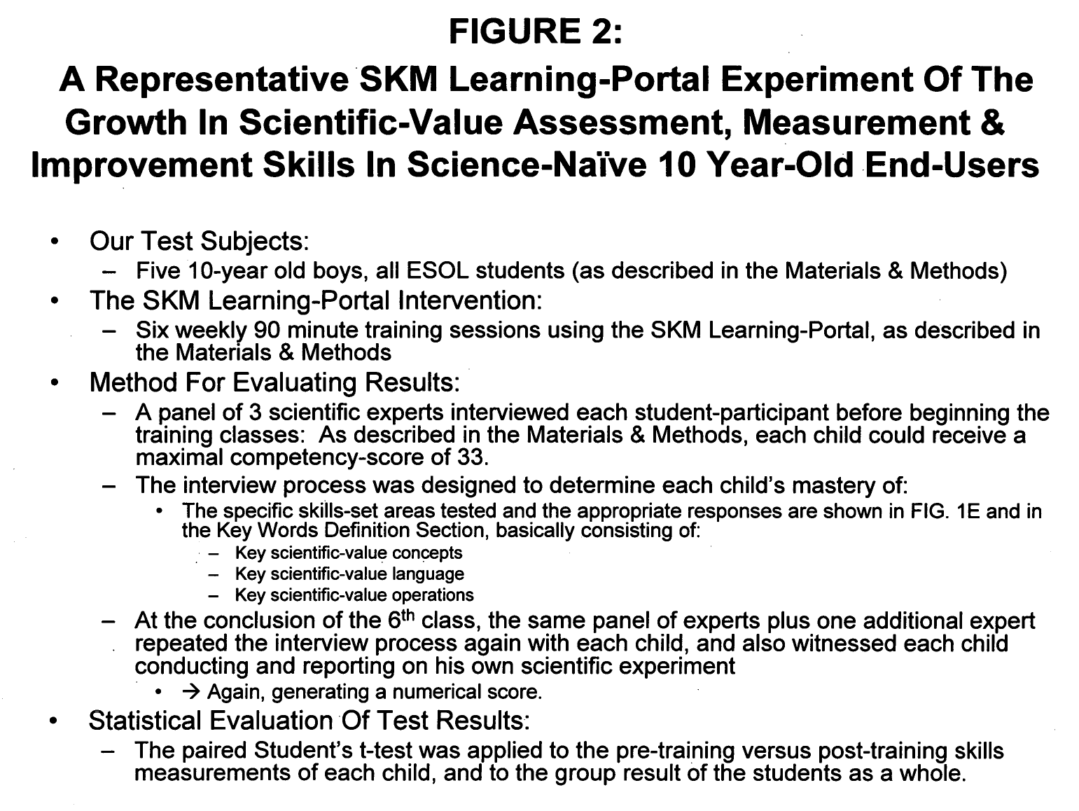

For the purposes of this invention, high scientific-value tends to increase whenever the scientific conversation and/or offering remains in the scientific learning-zone, that, in turn, is bounded by the 4 above-cited parameters (as shown in FIG. 1E).
The ‘Scientific-Data/Scientific-Information/Scientific-Knowledge Scientific-Learning Hierarchy’: Since the definition of ‘science’ derives from the Latin ‘scientia’, which means ‘knowledge’, the overall mission and focal point of all scientific discovery is to learn about (and otherwise acquire) additional scientific-knowledge.
   Usually all scientific-knowledge derives from new insights derived from scientific-information patterns, and once obtained, such scientific-knowledge also alters the process and the level of ability by which scientific-information patterns are scanned and evaluated by scientists in the future.
   In turn, all scientific-information derives from new insights derived from scientific-data patterns, and once obtained, such scientific-information, particularly as it results in new scientific-knowledge, also alters the process and the level of ability by which scientific-data patterns are scanned and evaluated by scientists in the future.
   Since the purpose of the scientific method is to provide practioners with a discipline and a structure to the process of creating new scientific-knowledge, scientific-knowledge is currently considered to be the most valuable form of learning in the scientific-data/scientific-information/scientific-knowledge hierarchy, particularly because of the new degree of predictability and control achieved from the new scientific understanding (http://wordnet.princeton.edu/perl/webwn?s=scientific %20knowledge).
The ‘10 Scientifically-Measurable Dimensions Of Living Systems’: The scientific tool of the present invention is a thought-organizing system for analyzing the structure, function, stability, and most importantly the inter-connected complexity of living entities within the Natural World, starting with the concept that all living organisms are systems of interconnected atoms, interconnected molecules, interconnected cells and interconnected organs. This level of detailed scientific understanding appears vital for scientifically predicting and scientifically supporting the progressive complexity of living systems particularly on a global scale.
   At the core of this system of analysis in the biological sciences is THE CELL, which is the most basic, indivisible functional unit of all living systems.
      Long-lived cells possess a quality of high scientific referential-meaning (see definition below).
   Any given CELL can be scientifically-viewed as being comprised of a series of stable and inter-connected MOLECULAR entities, chiefly lipids, carbohydrates, polypeptides, and nucleic acid biomolecules.
      Highly-stable molecules possess a quality of high scientific referential-meaning.
   In turn, each BIO-MOLECULE can be viewed as an enduring set of stable and inter-connected ATOMIC organizational structures, composed primarily of the hydrogen, carbon, nitrogen, carbon and phosphorous atoms.
      Normally, in most scientific studies, the atom is the most practical and basic level of scientific analysis.
      Highly-stable atoms (like helium) and highly-stable molecules (like certain structural proteins) possess a quality of high scientific referential-meaning.
   Certain life forms are able to move beyond the simple cell level in their complexity, by forming stable multi-cellular organizational structures called ORGANISMS:
      In most multi-cellular organizational structures, there is a division of cellular labor and specialization of cellular function, that produces ORGANS within the ORGANISM.
      Long-lived organisms possess a quality of high scientific referential-meaning.
   Certain independent organisms are able to produce stable, meaningful, and highly-interconnected MULTI-ORGANISM societal structures, including the various universal manifestations of all human civilizations.
      In all multi-organism societal structures, a special structure for identifying within and without, including other animals, is present with close genetic-relatedness, called the FAMILY structure.
         Enduring family structures in multi-organism societies possess a quality of high scientific referential-meaning.
      In many cases, the multi-cellular interactive structure extends to include stable and meaningful relationships with non-genetic, yet physically-close NEIGHBOR animals, like the symbiosis between clownfish and the sea anemone.
      Among the various forms of multi-organism societal-structures, humans have specifically extended their interactive capabilities to create highly-meaningful, useful, and relatively-stable division-of-work-and-responsibility structures at the PROFESSIONAL, NATIONAL and GLOBAL levels.
         In normal day-to-day scientific operations, the global perspective is broadly considered to be the most sophisticated and complex level of scientific analysis, in large part because of the awareness of multiple levels of scientific interconnectedness that is required. This level of scientific understanding is necessary in order to formulate new sustainable structures and solutions in the modern world (http://obssr.od.nih.gov/Documents/Conferences And W orkshops/HigherLevels_Final.PDF).
A ‘Scientific Community-of-Practice’ (http://myfirecommunity.net/documents/CoP_Snyder_report.pdf—also known as A Social Network http://en.wikipedia.org/wiki/Social_network): The operation of a more or less stable grouping of scientists (generally associating with each other for at least a period of time), when viewed with regard to the qualities and the functional power of the informal dimensions of their mutual interactions.
   The informal community-of-practice dimension of any multi-animal social network grouping, including humans, is the principal repository of the knowledge-assets and the learning-assets of the specific multi-animal societal structure under scientific examination.
   Most grant-funded science and medicine in Western nations, especially in the United States, is conducted in a high-value community-of-practice setting.
‘Scientist-Centric Discoveries and Offerinis’:
   Scientific inventions and other products of the scientific discovery process that are mainly understandable (in their basic operational aspects) only within the pertinent scientific community.
   This scientist-centric characteristic may or may not place limitations on the ultimate use and utility of this invention by non-scientists.
‘Scientific-Sustainability’: The process whereby scientific inventions, discoveries and other products are created, in a manner that meets the needs of the world's population without damaging the ability of future generations to sustain themselves. The growing complexities of the modern world have created a demand for scientifically-sustainable solutions and structure. Scientifically-sustainable solutions and structures tend to be enduringly useful because they possess both high scientific referential-meaning and high scientific-purpose. At a minimum, such scientifically-sustainable solutions should meet the actual needs of pertinent consumers, while not removing scientific options from future generations. (http://www7. nationalacademies.org/sustainabilityroundtable/index.html).
   High Scientific Referential-Meaning: Any next-step in growth in stable scientific evolutionary complexity, including the creation of stable man-made scientific discoveries and solutions and structures, for which all component parts experience an enduring mutual attraction to one another.
      As an example, the 2 electrons, the 2 protons, and the 2 neutrons that comprise the common helium atom constitute (when collectively considered as a new structure or new composition, beyond the complexity level of simple hydrogen) a new level of high scientific referential-meaning.
         Scientists employ the established scientific characterizations of the remarkable stability of such atomic compositions to create highly-predictive maps and schemas, including enduring reference landmarks concerning atomic scientific-knowledge.
         This level of predictability includes the understanding that modern scientists now possess concerning the chemical bonding behavior of the atoms, as contained in the Periodic Table (http://en.wikipedia.org/wiki/Periodic_table).
         This stability of structure and function, at the atomic level, provides the scientific community with enduring, meaningful, reference landmarks of scientific-knowledge about atomic functionality and predictability.
      Molecular complexity can also display high scientific referential-meaning. For example, the assembled component atomic parts of most DNA molecules within living cells display a level of stability that reflects high scientific referential-meaning,
         Ever since the completion of the Human Genome Mapping Project (http://www.ornl.gov/sci/techresources/Human_Genome/home.shtml), scientists have been employing the enduring functional stability of such DNA constructs to create schemas, including enduring and meaningful reference landmarks of scientific-knowledge about human DNA functionality and predictability.
      The same property of high scientific referential-meaning applies to the construction of various cell types, such as myocardial cells or neuronal cells. Stable cells exist as a result of the cooperative and stable interconnected arrangement of the biomolecules that compose them.
         The assembled component molecular parts of viable living cells display a level of stability that reflects high scientific referential-meaning.
         A wide variety of modern scientific models and schemas concerning the structure and function of cells and cell lines (http://www.atcc.org/Cultures/str.cfm), including histologic and anatomic maps, constitute enduring reference landmarks of scientific-knowledge within the scientific community.
         For example, the ability to scientifically predict and control the behavior of stem cells (http://stemcells.nih.gov), depends upon the scientific elucidation of the stable patterns of cellular structure and function, that in turn provide high levels of scientific referential-meaning to the scientists studying various types of viable cells.
      Each viable organism can be viewed scientifically as a result of a stable, tightly-interconnected arrangement of the various cell-types which interact to create a single, larger biological entity.
         In the case of humans, as many as 10 trillion cells are contained within a single organism.
         The assembled component cellular parts of a viable organism display a level of stability that reflects high scientific referential-meaning
         The entire scientific field of taxonomy (http://en.wikipedia.org/wiki/Scientific classification), centres around classification of the genus and species of life forms and depends upon such stability of organism structure and function.
         This level of organism stability provides another level of scientific referential-meaning to the scientific community.
      The principle of high scientific referential-meaning also applies to complex multi-organism social structures (http://www.caldwellzoo.org/programs/animalfamilies.pdf) that exist between various members of certain species. For example, high scientific referential-meaning found in honey bee colonies.
         The level of scientific referential-meaning in such multi-animal social structures is so high, and thus so stable, that there is no evidence of any viable individual honey bee that is not an active member of an intact honey bee social structure (a honey bee hive colony).
         The levels of multi-animal interactive complexity necessarily include interactions between DNA-related members (‘family’), as well as interactions with non-DNA related animals that share the same living space (‘neighbors’)
         In the human species, the levels of multi-animal interactive complexity also include interactions of an economic nature (‘professional’) as well as at the cultural-political level (‘national’), as described in the term. “The 10 Scientifically-Measurable Levels of Living Systems”
         Such examples of remarkable consistency and predictability in the scientific structure and behavior of multi-animal associations serve as reference-landmarks for scientists engaged in the study and analysis of other multi-animal societies.
         When viewed from its broadest perspective, any new evolutionary solution and/or structure that displays high scientific referential-meaning is able to organize its component parts with a sufficient level of sustainable association, that in turn permits the new structure/solution to defy various dissociative/disaggregating natural forces of entropy (at least for a while).
   ‘High Scientific-Purpose’: The experience, at the level of any given component part of a new scientific discovery or solution or structure, of a momentum in the specific direction of supporting the overall integrity of the ‘bigger-than-self’ new solution or structure. High-purpose components functionally reject their free state(s), in preference of their association with and support of the larger-than-self more-complex solution/structure.
In light of the above elucidations, the property of high scientific-purpose can thus be said to apply to:
   Each of the individual electrons in a Helium ‘atom’,
   Each of the various atomic components that comprise a stable DNA ‘molecule’,
   Each of the various molecular components that comprise a viable myocardial ‘cell’,
   Each of the viable cells that support the viability of a jellyfish ‘organism’, and
   Each of the viable individual bees in a stable ‘multi-organism social structure’, i.e., a honey bee colony.
   As described above (in the Scientific-Meaning definition), the presence of a critical mass of component parts possessing scientific-purpose is required to create new scientific solutions and/or structures with high scientific referential-meaning.
      Put another way, the level of scientific referential-meaning of any given new evolutionary structure/solution is directly related to the level of scientific-purpose that is displayed by each of the component parts of the new structure/solution times the percentage of component parts that display high levels of scientific-purpose.
      The ability of any new scientific structure/solution to counter the destructive/dissociative forces of entropy depends upon high levels of component scientific-purpose and the net overall scientific referential-meaning of the entire structure/solution.
‘Scientific-Information-Overload’: Too much scientific-information to process in any useful way. In humans the Information Overload Syndrome tends to be quite stressful, leaving an affected individual feeling (even if temporarily) ‘dazed and confused.’
‘Scientific-Knowledge-Overload’: Too much scientific-knowledge to act upon effectively, also known as a ‘High Know-Do Gap’. In humans the Knowledge Overload Syndrome tends to be quite stressful, leaving an affected individual feeling progressively inadequate, ignorant or even guilty at times.
‘Scientific-Discipline-Fragmentation’: A functional scientific equivalent to ‘the Tower Of Babel’, in which professional members of different scientific disciplines address problems in such diverse ways, with such different tools and language, that their activities are no longer perceived as directly relevant or intelligible to one another.
   This syndrome is also known as ‘The Professional Silo Syndrome.’
   For example, an astrophysicist may not know anything about genomics or proteomics and a molecular biologist may not know anything about astrophysics or astronomy.
‘Scientific-Disposability’: The opposite of scientific-sustainability. Typically, scientific offerings, solutions and/or structures that suffer from high levels of scientific-disposability, possess one or both of the following characteristics:
   Low Scientific Referential-Meaning: The opposite of high scientific referential-meaning.
   Low Scientific-Purpose: The opposite of high scientific-purpose.
‘Scientific Knowledge Management Learning-Portal’: A structured gateway for viewing and analyzing any scientific problem, conversation, discovery or component of the scientific process itself. Such structured learning-portal gateways for scientists, and now non-scientists, create the structured parameters that promote high scientific-value, and can be readily created in real face-to-face interactions, and may also be created in virtual, technology-assisted interactions.
   It may be noted that in the vast majority of instances scientific learning of all types is more impactful and enduring when conducted in the face-to-face setting.
   In most cases, virtual technology-driven learning experiences tend to be more transactional, not totally equivalent to the ‘real’, and thus usually less impactful.

The proper use of the scientific knowledge management learning-portal leads directly toward an experience of higher levels of scientific-value, and leads directly away from the Scientific-information Overload, Scientific-Knowledge Overload, Scientific-Discipline Fragmentation, Scientific-Disposability, and Scientist-Centric Discoveries and Offerings syndromes.
‘End-User-Centric Scientific Discoveries/Offerings’: A deliberate choice to direct the final control of scientific conversations in favor of the end-user of the scientific product or process.

### Materials and Methods

The implementation of scientific knowledge management learning-portal-mediated, end-user-driven, scientific conversations and interactions assumes that the end-user is a non-scientist, although the same system and method is also ideal for professional scientists, particularly when they are interfacing with non-scientific customers and/or colleagues.

The preferred materials and methods of the present invention which has been designated and defined herein above as the scientific knowledge management learning-portal for assessing, measuring and improving scientific-value are now described.

### Study Participants

The subjects who have participated in research studies of the effectiveness of the scientific knowledge management learning-portal for assessing, measuring and improving scientific-value include a total of more than 20 children, from ages 10 to 15, as well as more than 5 adults, from ages 30 to 52: Most of the studies of the effectiveness of the scientific knowledge management learning-portal for assessing, measuring and improving scientific-value have utilized the face to face version of the invention, instead of the digitally-assisted versions (as with most systems of learning, it is assumed that the face to face experiences of the invention are the most effective in promoting authentic new skills development).

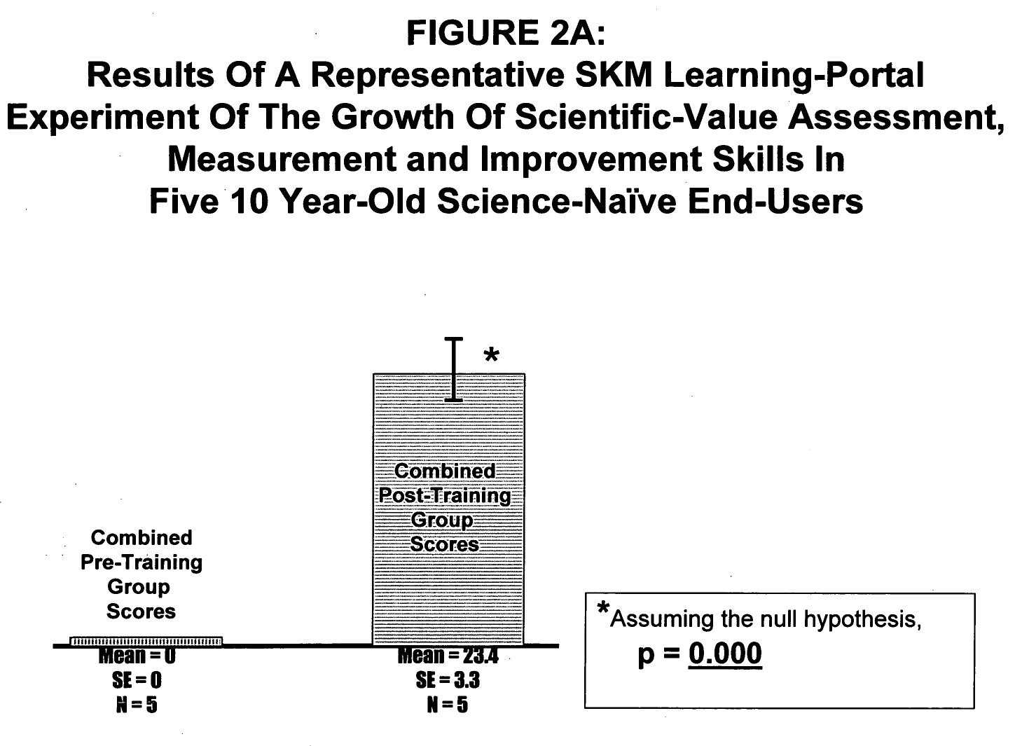

FIG. 2 shows the results of a representative experiment with five 10 year-old boys that were exposed to the scientific concepts and scientific language contained in the scientific knowledge management learning-portal for assessing, measuring and improving scientific-value. The five boys were part of a group of children, all in the United States for less than one year, who were designated as unskilled in both English and American culture, and thus were formally assigned by the public school system to an English (as a) Second Language (ESOL) program. All of the 10 year old children in the ESOL program of a public Washington D.C. Area elementary school were provided with a visual outline of the benefits of the scientific knowledge management learning-portal for assessing, measuring and improving scientific-value, and an invitation and a parental consent form was sent home with each ESOL child (the invitation and consent form were written in both English and Spanish) to participate in a free after-school childhood science enrichment program utilizing the invention, consisting of six 90 minute sessions, over a period of about 3 weeks.

The five boys that participated in the SKM learning-portal study were the only ESOL students whose parents filled out the mandatory consent form. None of these 5 student-participants was able to communicate effectively in English, however all of the children spoke either Spanish or some version of French, and thus the instructors of the scientific knowledge management learning-portal training program were able to communicate effectively with them.

### Study Design

### Pre-Study and Post-Study Assessments of Acumen of Participants Prior to and After Exposure to the Scientific Knowledge Management Learning-Portal for Assessing, Measuring and Improving Scientific-Value:

The 5 student-participants were informed that they would each receive an up-front pre-training interview to determine their pre-study skills-level by 3 scientific experts. These same experts would also later provide the students with an orientation to the appropriate use of the scientific knowledge management learning-portal for assessing, measuring and improving scientific-value.

Before the initiation of the 1^{st} training class, and after making each child comfortable, the panel of scientific experts reviewed with every child each of the key scientific concepts that are contained in the Graphics Section and in the Key Definitions Section of the portal pertaining to the operation of the scientific knowledge management system for assessing, measuring and improving scientific-value. Each child was given an opportunity to explain each scientific term or item, first in English, and then in the child's native language, to determine the child's level of comprehension about each item. A score of 1 point was given for each term and concept correctly answered, in either language. A score of 0 point was given for each term and concept that was not correctly answered in either language.

At the conclusion of the 6^{th} class, a group of 4 scientific experts was convened to listen to each child's articulated explanation, in English only, of each of the key concepts and terms that comprise the operation of the SKM learning-portal. A score of 1 point was given for each term and concept correctly answered in English, and a score of 0 point was given for each term and concept that was not corrected answered in English. In addition, each child was observed during the last class while the child participated in the conduct of a real-time scientific experiment, in order to determine the level of understanding of 5 additional scientific parameters:
1. Reproducible Scientific Evidence
2. Predictive Scientific Best-Practices
3. Scientific-Interconnectedness
4. Scientific-Sustainability
5. Scientific-Value

Each child was given an additional score of 1 point for each of these items that they could demonstrate having understood, or a score of 0 for each item that they failed to understand.

In total, each child had the possibility of receiving 33 points, if he had displayed a proper mastery of all of the pertinent terms and concepts.

### Statistical Methods

All scoring of verbally-expressed scientific skills, pertinent to the present invention, was performed at the pre-training level by a panel of three science experts, with the addition of a fourth independent expert to the panel at the post-training assessment.

Baseline scores for each individual were assigned a value of 100% and changes in this value were monitored throughout the study. Standard errors for each group's test scores were determined and the change in skills by the group as a whole were then compared by the paired “t” test method.

### Other Pertinent Materials and Methods

Immediately upon completion of the pre-training skills-assessement, the students were issued their own personal scientific laboratory notebook, adapted to meeting the specific training needs of each student, which served as their personal SKM learning-journal.

As shown in FIG. 1A, after learning the definition of the term ‘science’, the group of students learned the 8 basic steps of the Scientific Method. These 8 steps were then entered into their laboratory notebook/personal learning-journal, in a manner similar to the display shown in FIG. 1A. Then the children began to design and conduct experiments of their own, in conformance with the specific steps of the Scientific Method. More than any other concept, the emphasis upon the tools for Acquiring Reproducible Evidence, by means of the Scientific Method, was stressed.

Next, as shown in FIG. 1B, the class participants also received a series of instructions that were designed to teach them the specific steps in the scientific-learning process, from ‘scientific-data’ to ‘scientific-information’ to authentic ‘scientific-knowledge’. These steps were then entered into their laboratory notebook/personal learning-journal, in a manner similar to the display shown in FIG. 1B. Then, the children engaged in a number of class exercises in which they were asked to distinguish between ‘scientific-data’, ‘scientific-information’, and ‘scientific-knowledge, using real situations usually encountered during the course of scientific laboratory research. More than any other concept, the emphasis upon the acquisition of tools for evaluating Predictive Scientific Best-Practices, that are acquired by means of the Scientific Method.

Next, as shown in FIG. 1C, the class participants received a series of instructions that were designed to familiarize them with the inner workings of the basic levels of scientific analysis of living systems, including:
‘Atoms’, particularly the bio-atoms: Students learned how to use the Periodic Table.
‘Molecules’, as stable poly-atomic structures, particularly the bio-molecules. Students learned about the specific structure of carbohydrates, proteins, lipids and nucleic acids and how to use resources such as the Human Genome.
‘Cells’, of all types as stable poly-molecular structures, particularly human cells. Students learned the basic structure of cells and of cellular organelles and how to use the microscope.
‘Organs’, as stable poly-cellular structures, particularly in humans. Students learned the basics of Human Anatomy.
‘Organisms’, as a higher level of stable poly-cellular structures of all varieties, and particularly humans. Students learned how individual animals survive, how organisms know what they know, how organisms defend themselves immunologically, and how individual organisms learn new skills.
Poly-organism societies of all types, particularly at the level of genetic-relatedness or ‘family’. Students learned about the operations of the community-of-practice dimension of human interaction, at the level of genetic-relatedness, or ‘family’. Special attention was paid to the specific knowledge-assets and learning-assets that are employed at this level of any multi-animal social structure. Examples include the study of bee colonies, ant colonies, and local human families.
Poly-organism societies of all types, particularly at the level of non-genetic-relatedness yet sharing the same environment or ‘neighbor’. Students learned about the operations of the community-of-practice dimension of space-sharing interactions at the level of neighborhoods. Special attention was paid to the specific knowledge-assets and learning-assets that are employed at this level of any multi-animal social structure. Examples included the study of bees, ants, and local human neighborhoods.
Human poly-organism societies, particularly at the level of ‘professionals.’ Students learned about the operations of the community-of-practice dimension of human economic interactions, particularly with regard to scientific professional interactions. Students are exposed to scientific societies, the formal licensing required for certain scientists, and the regulations that govern scientific behavior. Special attention was paid to the specific knowledge-assets and learning-assets that are employed at this professional level of any human social structures, especially in the modern scientific workplace.
Human poly-organism societies, particularly at the level of ‘national’. Students learned about the operations of the community-of-practice dimension of human interactions, at the level of establishing and maintaining national political boundaries. Special attention was paid to the specific knowledge-assets and learning-assets that are employed at this level of human multi-animal social structures. Simple national maps and their evolution over time serve to illustrate this scientific principle. And finally, students learned how to adopt a ‘global’ scientific perspective on such issues as ‘air quality’, ‘food contaminants’, ‘ocean fishing’ and ‘global warming’.

These 10 levels of scientific analysis were then entered into their laboratory notebook/personal learning-journal, in a manner similar to the display shown in FIG. 1C. More than any other concept, the emphasis upon the acquisition of an understanding of scientific interconnectedness was emphasized at this stage.

Next, as shown in FIG. 1D, the class participants received a series of instructions that were designed to familiarize them with the inner workings of Scientific-Sustainability:
‘Scientific Referential-Meaning’, and
‘Scientific-Purpose’
particularly focusing upon specified examples at all 10 levels of scientific-analysis, as set forth herein above.

These 10 levels of scientific analysis were then entered into their laboratory notebook/personal learning-journal, in a manner similar to the display shown in FIG. 1D. More than any other concept, the emphasis upon the acquisition of an understanding of enduring scientific usefulness was stressed at this stage.

Ultimately, the following four separate dimensions of scientific thinking were brought together in the mind of each student, by encouraging the student to formulate their own scientific questions, and to research their own scientific projects thoroughly:
Acquiring Reproducible Evidence
Evaluating Predictive Best Practices
Understanding Scientific Interconnectedness
Understanding Enduring Scientific Usefulness.

Additional scientific references, customized for the specific question(s) of the student, were provided to the student as needed. As shown in FIG. 1E, the goal at this phase of training was to inspire the student to create, develop and conduct his/her independent scientific experiment and to provide some ongoing assessment of its scientific-value. Students were taught to record each step in the discovery process in their scientific notebook/personal learning-journal, as they are taught to monitor the quality of their own thought processes, as well as those of their fellow students, by trying to maintain ongoing scientific processes squarely within the scientific knowledge management learning-zone.

Student-participants in this study were ultimately assessed for the quality of their skills in assessing, measuring, and improving scientific-value by direct observation, translated into a numerical value, by a panel of scientific experts (as described above), analogous to the rigor of direct professional observation with regard to airplane flying skills or neurosurgery skills. At the same time, as with the airplane pilotry and neurosurgery examples, it was possible to gain a close approximation of the skill level of a trainee, using technology-assisted skills-assessment tools. For the scientific knowledge management learning-portal, this can involve a series of computer-driven testing tools requiring precision in the assessment of ‘what's important’, ‘what's irrelevant’ and ‘what's quite dangerous’ in a simulated computer environment, that also requires the trainee to display high speed as well as precision in the usage and placement of pertinent scientific-value tools.

The entire layered-training exercise and experience in the proper use of the scientific knowledge management learning-portal for assessing, measuring and improving scientific-value was completed within the time frame as described above using both face to face learning interactions, as well as technology-assisted learning-formats.

### The Preferred Use Of the Scientific Knowledge Management Learning-Portal for Assessing, Measuring and Improving Scientific-Value.

The present invention has many current and envisioned usages, both in face to face learning settings, as well in technology-assisted learning-formats including the following:
Early exposure of non-scientists, of any age, to the field of scientific knowledge management as this skill leads to enhanced abilities to assess, measure and improve scientific-value.
Assistance to scientific professionals in the field of scientific knowledge management, particularly those desirous of enhancing their abilities to assess, measure and improve scientific-value in their interactions with customers and colleagues, including in their communications with non-scientific customers and/or colleagues.
The meaningful outline/presentation/overview of any specific new scientific idea or project, such as the initiation and roll-out of a complicated, multi-site, new drug development research project, or the summary provided at the completion of the same process.
The provision of customer-centric scientific services, such as healthcare and health-promotion services, via the Internet or in similar technology-assisted settings.

The goal in each of these venues is to provide the student or customer (or other type of end-user) with the tools for learning the specific parameters within the Scientific Knowledge Management Learning Zone (a scientific playing field), by:
Properly Using The Scientific Method To Acquire Reproducible Evidence;
Properly Engaging In Scientific-Learning To Critically Evaluate Predictive Knowledge;
Properly Analyzing Living Systems At All 10 Levels Of Scientific Analysis To Understand The Degree Of Scientific Interconnectedness;
Mastering Scientific-Sustainability Tools To Ensure Enduring Scientific Usefulness.

The proper use of all four of the above-noted boundaries of the Scientific Knowledge Management Learning-Portal for Assessing, Measuring and Improving Scientific-Value also allows the end-users to stay in the scientific knowledge management learning zone, and thus remain in control of the scientific-value of scientific conversations about ideas, discoveries and/or other forms of scientific-offerings.

It is important to note that the potential capability of any individual to assess, measure and improve scientific-value is limit-less. Hence, there are no known limits to the levels of depth that can be achieved when exploring scientific-value, using the instant Scientific Knowledge Management Learning-Portal for Assessing, Measuring and Improving Scientific-Value invention. For instance, the results cited in this application refer to Introductory-level learning experiences. However, the instant invention can be and has also been used effectively at the advanced, the accelerated and at the Masters degree level.

### Results of the Representative Study

Prior to initiation of the study, testing of the participants' pre-training acumen was determined and the mean baseline scores of the group of 5 students was found to be (out of a possible total of 33). (FIG. 2A).

After only six 90 minute training sessions with the Scientific Knowledge Management Learning-Portal for Assessing, Measuring and Improving Scientific-Value, the same 5 students were re-tested and were found to have a group mean score of 23.4 with a standard error of 3.3. (FIG. 2A). Assuming the null hypothesis, the p-value for this result was 0.000.

It should be noted that a multi-step layered-learning process is required for gaining proficiency in understanding the parameters, the language, and the basic concepts for assessing, measuring, and improving scientific-value in the minds of novice participants, regardless of their scientific background in that subject area. First, participants need to clearly understand and visualize the basic concepts which are central to the use of the Scientific Knowledge Management Learning-Portal for Knowledge Management Learning-Portal for Assessing, Measuring and Improving Scientific-Value tool provides, for the first time, a rapid and successful tool for gaining proficient skills in an area of sophisticated science which was not heretofore possible. The utility of quickly acquiring the skills to assess, measure and improve scientific-value in the modern, high-tech, science-oriented setting cannot be overemphasized. The Scientific Knowledge Management Learning-Portal for Assessing, Measuring and Improving Scientific-Value system and method allows novice participants to rapidly program their own skills in assessing, measuring and improving scientific-value in a self-pacing, cost effective and time efficient manner.

In summary, the invention comprises:
1. A scientific knowledge management method and system for use by an ordinary individual without formal training in science, as well as by any trained scientific professional, to rapidly assess, measure and improve scientific-value of a scientific discovery or offering, comprising the steps of:
(i) training a person, without prior knowledge of a science subject and without requiring said person to have more than high school reading skills, to acquire scientific data, information and knowledge using a scientific knowledge management learning portal and tool set, either in a face to face or in a technology-assisted setting that reaches a rigorous, end-user-driven interactive field for assessing, measuring and improving scientific-value; then
(ii) requiring the person in step (i) to acquire specific scientific problem-viewing and problem-solving skills by following instructions contained in said scientific knowledge management learning portal and tool set, including learning pertinent terminology and functional interactive operations that govern the operation of the scientific knowledge management learning portal; then
(iii) requiring said person to verbally interact with other similar scientific knowledge management learning portal end-user participants who have undergone training in analyzing scientific problems and paradigms, in a setting of a group of persons of similar training as in steps (i) and (ii), with feedback in face to face or in a technology-assisted reinforcement program; then
(iv) repeating step (iii) a plurality of times in face-to-face sessions or via technology-assisted instruction so that said person acquires the ability to rapidly assess, measure or determine the value of a scientific topic, without face to face or technology-assisted supervision, in a time period substantially less than that required in conventional methods while acquiring knowledge of the science subject in an amount at least equal to or more than that acquired by conventional methods.
2. The method of claim 1, wherein said scientific knowledge management toolset, including use of the scientific knowledge management learning portal, provides the end-user control over the value of scientific conversations and offerings, both in face to face and in technology-assisted settings.
3. The method of claim 2, further comprising a system for pre-testing and post-testing of scientific knowledge management abilities and scientific value assessment, measurement and improvement skills acquired by said person, utilizing a timed and guess-proof card assortment process whereby said person is forced to evaluate the value of newly-acquired scientific knowledge and concepts, thus producing a set of individual objective scores for said skills.
4. The method of claim 3, further comprising a set of specific additional scientific knowledge management training resources for boosting skills in any measured area of deficiency, with regard to an individual's scientific knowledge management abilities and scientific value assessment, measurement and improvement skills.
5. The method of claim 4, further comprising a system for registering and recording conceptual advances in science and scientific value learned by said person having undergone training in scientific knowledge management and scientific-value metrics training, including an array of recording options for new scientific ideas, new scientific questions and new scientific references that are automatically organized in a readily-retrievable format as contained in said scientific knowledge management learning portal for subsequent use by said person in a variety of ways, including periodic re-introduction of any specific scientific advance, onto said person's calendar, computer-screen or similar device.
6. The method of claim 1, wherein said portal and tool set includes a kit comprising pictorially illustrated class material, a series of science language cassette tapes, a set of instructions and feed-back material.

It is understood that the examples and embodiments of the present invention as described herein are for illustrative purposes only and not limiting and that various modifications or changes in light thereof will be suggested to persons skilled in the art and are included within the spirit and purview of this application and scope of the appended claims.

What is claimed is:

1. A scientific knowledge management method and system for use by an ordinary individual without formal training in science, as well as by any trained scientific professional, to rapidly assess, measure and improve scientific-value of a scientific discovery or offering, comprising the steps of:
(i) training a person, without prior knowledge of a science subject and without requiring said person to have more than high school reading skills, to acquire scientific data, information and knowledge using a scientific knowledge management learning portal and tool set, either in a face to face or in a technology-assisted setting that reaches a rigorous, end-user-driven interactive field for assessing, measuring and improving scientific-value; then
(ii) requiring the person in step (i) to acquire specific scientific problem-viewing and problem-solving skills by following instructions contained in said scientific knowledge management learning portal and tool set, including learning pertinent terminology and functional interactive operations that govern the operation of the scientific knowledge management learning portal; then
(iii) requiring said person to verbally interact with other similar scientific knowledge management learning portal end-user participants who have undergone training in analyzing scientific problems and paradigms, in a setting of a group of persons of similar training as in steps (i) and (ii), with feedback in face to face or in a technology-assisted reinforcement program; then
(iv) repeating step (iii) a plurality of times in face-to-face sessions or via technology-assisted instruction so that said person acquires the ability to rapidly assess, measure or determine the value of a scientific topic, without face to face or technology-assisted supervision, in a time period substantially less than that required in conventional methods while acquiring knowledge of the science subject in an amount at least equal to or more than that acquired by conventional methods.

2. The method of claim 1, wherein said scientific knowledge management toolset, including use of the scientific knowledge management learning portal, provides the end-user control over the value of scientific conversations and offerings, both in face to face and in technology-assisted settings.

3. The method of claim 2, further comprising a system for pre-testing and post-testing of scientific knowledge management abilities and scientific value assessment, measurement and improvement skills acquired by said person, utilizing a timed and guess-proof card assortment process whereby said person is forced to evaluate the value of newly-acquired scientific knowledge and concepts, thus producing a set of individual objective scores for said skills.

4. The method of claim 3, further comprising a set of specific additional scientific knowledge management training resources for boosting skills in any measured area of deficiency, with regard to an individual's scientific knowledge management abilities and scientific value assessment, measurement and improvement skills.

5. The method of claim 4, further comprising a system for registering and recording conceptual advances in science and scientific value learned by said person having undergone training in scientific knowledge management and scientific-value metrics training, including an array of recording options for new scientific ideas, new scientific questions and new scientific references that are automatically organized in a readily-retrievable format as contained in said scientific knowledge management learning portal for subsequent use by said person in a variety of ways, including periodic re-introduction of any specific scientific advance, onto said person's calendar, computer-screen or similar device.

6. The method of claim 1, wherein said portal and tool set includes a kit comprising pictorially illustrated class material, a series of science language cassette tapes, a set of instructions and feed-back material.
